(19) United States
(12) Patent Application Publication
(10) Pub. No.: US 2026/0050586 A1
(43) Pub. Date: Feb. 19, 2026

(54) APPARATUS FOR RETRIEVAL AUGMENTED GENERATION BASED ON HYPERDIMENSIONAL COMPUTING AND METHOD THEREOF

(71) Applicant: COGA ROBOTICS CO.,LTD., Seoul (KR)

(72) Inventors: Il Hong SUH, Seoul (KR); Ye Seong KIM, Daegu (KR); Shin Hyoung JANG, Daegu (KR); Hyun Sei LEE, Daegu (KR)

(21) Appl. No.: 19/303,393

(22) Filed: Aug. 19, 2025

(30) Foreign Application Priority Data
Aug. 19, 2024 (KR) 10-2024-0110231
Jul. 9, 2025 (KR) 10-2025-0092394
Aug. 19, 2025 (KR) 10-2025-0114941

(51) Int. Cl. G06F 16/22; G06F 16/245

(52) U.S. Cl. CPC G06F 16/2264; G06F 16/2237; G06F 16/245

(57) ABSTRACT

Disclosed is a hyperdimensional computing-based retrieval-augmented generation apparatus. The retrieval-augmented generation apparatus may include a network interface; at least one processor operatively connected to the network interface; and at least one memory operatively connected to the at least one processor, and the at least one memory may store instructions that, when executed, cause the at least one processor to generate a target binary hypervector through hyperdimensional computing (HDC)-related operation for a target document, to generate a target graph by connecting at least one binary hypervector included in a hyperdimensional space in a retrievable structure based on identifying the hyperdimensional space in which the target binary hypervector is included, and to determine a retrieved document similar to a query hypervector in the hyperdimensional space by applying the query hypervector to the target graph based on receiving the query hypervector.

### CROSS-REFERENCE TO RELATED APPLICATION

This application claims priority to and the benefit of Korean Patent Application No. 10-2024-0110231, filed on Aug. 19, 2024, Korean Patent Application No. 10-2025-0092394, filed on Jul. 9, 2025, and Korean Patent Application No. 10-2025-0114941, filed on Aug. 19, 2025, the disclosures of which are incorporated herein by reference in their entireties.

### BACKGROUND

### Technical Field

The following example embodiments relate to a retrieval-augmented generation (RAG) apparatus and a retrieval-augmented generation method.

### Related Art

The conventional retrieval-augmented generation (RAG) system has mainly employed a method of storing external knowledge documents in a high-dimensional real-valued embedding space, retrieving a document similar to a query of a user, and generating text based on the retrieved document. The conventional RAG system typically utilizes a pre-trained transformer-based deep learning model for document embedding and retrieval, and extracts a relevant document by performing Approximate Nearest Neighbor Search (ANNS) for large-scale vector data.

However, the real-valued high-dimensional embedding space suffers from high computational complexity and rapidly increasing memory usage, which limits scalability as the number of documents increases. In particular, in a large-scale corpus environment with millions of documents, it is difficult to perform brute-force search across all documents within a realistic response time, and vector indexes also require a lot of memory.

To solve these issues, there is a need for a method that increases memory efficiency, computational speed, and search accuracy by providing a hyperdimensional computing-based framework that projects a transformer-based token embedding into a high-dimensional binary hypervector and then uses the same as document representation.

### SUMMARY

Example embodiments may effectively maintain the relationship structure between documents without directly storing or comparing the entire large-scale document corpus as real-valued vectors by converting a target document to a binary hypervector through a hyperdimensional computing operation and by constructing a target graph connected in a retrievable structure according to similarity between binary hypervectors, may significantly reduce memory usage compared to a real-valued embedding method, and may also significantly improve scalability and response speed of a system by performing processing much lighter and faster than the existing high-cost operations since integer bit-level operations are possible.

Example embodiments may effectively determine semantically related retrieved documents by receiving a query hypervector and then applying the query hypervector to a target graph and by searching for similar binary hypervectors within hyperdimensional space, may reflect sematic proximity through Hamming distance-based search between adjacent nodes in the hyperdimensional hypervector space, and may precisely retrieve semantically similar documents without loss of retrieval accuracy in conjunction with graph-based step-by-step beam search.

However, technical subjects are not limited to the aforementioned technical subjects and still other technical subjects may be present.

A retrieval-augmented generation apparatus according to an example embodiment may include a network interface; at least one processor operatively connected to the network interface; and at least one memory operatively connected to the at least one processor, and the at least one memory may store instructions that, when executed, cause the at least one processor to generate a target binary hypervector through hyperdimensional computing (HDC)-related operation for a target document, to generate a target graph by connecting at least one binary hypervector included in a hyperdimensional space in a retrievable structure based on identifying the hyperdimensional space in which the target binary hypervector is included, and to determine a retrieved document similar to a query hypervector in the hyperdimensional space by applying the query hypervector to the target graph based on receiving the query hypervector.

In an example embodiment, the at least one memory may store instructions that, when executed, cause the at least one processor to acquire embedding tokens (vectors) by applying, to a pretrained transformer encoder, each of a plurality of tokens that constitute the target document, and to acquire a token hypervector in which the embedding tokens are mapped to a real-valued space of a target dimension related to the hyperdimensional computing, based on a fixed random projection matrix.

In an example embodiment, the at least one memory may store instructions that, when executed, cause the at least one processor to identify an attention mask for the transformer encoder, and to perform update to exclude, from the token hypervector, a token that is meaningless for the hyperdimensional computing-related operation based on the attention mask.

In an example embodiment, the at least one memory may store instructions that, when executed, cause the at least one processor to perform binarization of the token hypervector by applying a sign function to each target dimension of the token hypervector, and to generate the target binary hypervector as a result of performing binarization of the token hypervector.

In an example embodiment, the at least one memory may store instructions that, when executed, cause the at least one processor to store the target binary hypervector in the at least one memory in a compressed format by performing bit-packing that divides the target binary hypervector into predetermined unit sizes based on the number of bits of the target binary hypervector.

In an example embodiment, the at least one memory may store instructions that, when executed, cause the at least one processor to determine each of the at least one binary hypervector to be unassigned, to determine the unassigned binary hypervector as a temporary vector based on a similarity threshold based on a Hamming distance between the at least one binary hypervector, and to generate a target cluster by clustering similar binary hypervectors among the at least one binary hypervector based on a greedy single-pass algorithm that includes binary hypervectors each of which the Hamming distance is less than the similarity threshold.

In an example embodiment, the at least one memory may store instructions that, when executed, cause the at least one processor to determine a centroid binary hypervector that represents the target cluster by determining a plurality of binary hypervectors included in the target cluster as a bit having a majority value for each target dimension, and to determine the centroid binary hypervector as a node of the target graph.

In an example embodiment, the at least one memory may store instructions that, when executed, cause the at least one processor to determine the Hamming distance between the centroid binary hypervector of a cluster adjacent to the target cluster and the centroid binary hypervector of the target cluster as an edge of the target graph, and to generate the target graph for an undirected graph by symmetrically determining the edge.

In an example embodiment, the at least one memory may store instructions that, when executed, cause the at least one processor to randomly determine an entry node among at least one node included in the target graph and then determine an additional entry node based on a predetermined beam size and a Hamming distance, to determine a candidate document based on comparison between a plurality of binary hypervectors included in a cluster of each of the entry node and the additional entry node and the query hypervector, and to determine the retrieved document based on the candidate document.

In an example embodiment, the at least one memory may store instructions that, when executed, cause the at least one processor to identify a neighbor node that is an adjacent node connected to the entry node using an edge, to determine a comparative candidate document based on comparison between a plurality of binary hypervectors included in a cluster of the neighbor node and the query hypervector, and to determine the retrieved document by performing update of the candidate document based on comparison between a first score between the candidate document and the query hypervector and a second score between the comparative candidate document and the query hypervector.

A retrieval-augmented generation method according to an example embodiment may include generating a target binary hypervector through hyperdimensional computing (HDC)-related operation for a target document; generating a target graph by connecting at least one binary hypervector included in a hyperdimensional space in a retrievable structure based on identifying the hyperdimensional space in which the target binary hypervector is included; and determining a retrieved document similar to a query hypervector in the hyperdimensional space by applying the query hypervector to the target graph based on receiving the query hypervector.

In an example embodiment, the generating of the target binary hypervector may include acquiring embedding tokens (vectors) by applying, to a pretrained transformer encoder, each of a plurality of tokens (vectors) that constitute the target document; and acquiring a token hypervector in which the embedding tokens (vectors) are mapped to a real-valued space of a target dimension related to the hyperdimensional computing, based on a fixed random projection matrix.

In an example embodiment, the generating of the target binary hypervector may include identifying an attention mask for the transformer encoder; and performing update to exclude, from the token hypervector, a token that is meaningless for the hyperdimensional computing-related operation based on the attention mask.

In an example embodiment, the generating of the target binary hypervector may include performing binarization of the token hypervector by applying a sign function to each target dimension of the token hypervector; and generating the target binary hypervector as a result of performing binarization of the token hypervector.

In an example embodiment, wherein the generating of the target binary hypervector may include storing the target binary hypervector in the at least one memory in a compressed format by performing bit-packing that divides the target binary hypervector into predetermined unit sizes based on the number of bits of the target binary hypervector.

In an example embodiment, the generating of the target graph may include determining each of the at least one binary hypervector to be unassigned; determining the unassigned binary hypervector as a temporary vector based on a similarity threshold based on a Hamming distance between the at least one binary hypervector; and generating a target cluster by clustering similar binary hypervectors among the at least one binary hypervector based on a greedy single-pass algorithm that includes binary hypervectors each of which the Hamming distance is less than the similarity threshold.

In an example embodiment, the generating of the target graph may include determining a centroid binary hypervector that represents the target cluster by determining a plurality of binary hypervectors included in the target cluster as a bit having a majority value for each target dimension; and determining the centroid binary hypervector as a node of the target graph.

In an example embodiment, the generating of the target graph may include determining the Hamming distance between the centroid binary hypervector of a cluster adjacent to the target cluster and the centroid binary hypervector of the target cluster as an edge of the target graph; and generating the target graph for an undirected graph by symmetrically determining the edge.

In an example embodiment, the determining of the retrieved document similar to the query hypervector may include randomly determining an entry node among at least one node included in the target graph and then determining an additional entry node based on a predetermined beam size and a Hamming distance the target graph; determining a candidate document based on comparison between a plurality of binary hypervectors included in a cluster of each of the entry node and the additional entry node and the query hypervector; and determining the retrieved document based on the candidate document.

In an example embodiment, the determining of the retrieved document similar to the query hypervector may include identifying a neighbor node that is an adjacent node connected to the entry node using an edge; determining a comparative candidate document based on comparison between a plurality of binary hypervectors included in a cluster of the neighbor node and the query hypervector; and determining the retrieved document by performing update of the candidate document based on comparison between a first score between the candidate document and the query hypervector and a second score between the comparative candidate document and the query hypervector.

According to some example embodiments, it is possible to effectively maintain the relationship structure between documents without directly storing or comparing the entire large-scale document corpus as real-valued vectors by converting a target document to a binary hypervector through a hyperdimensional computing operation and by constructing a target graph connected in a retrievable structure according to similarity between binary hypervectors, to significantly reduce memory usage compared to a real-valued embedding method, and to significantly improve scalability and response speed of a system by performing processing much lighter and faster than the existing high-cost operations since integer bit-level operations are possible.

According to some example embodiments, it is possible to effectively determine semantically related retrieved documents by receiving a query hypervector and then applying the query hypervector to a target graph and by searching for similar binary hypervectors within hyperdimensional space, to reflect sematic proximity through Hamming distance-based search between adjacent nodes in the hyperdimensional hypervector space, and to precisely retrieve semantically similar documents without loss of retrieval accuracy in conjunction with graph-based step-by-step beam search.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a block diagram illustrating a retrieval-augmented generation apparatus according to an example embodiment;

FIG. 2 is a flowchart illustrating a retrieval-augmented generation method according to an example embodiment;

FIG. 3 is an example of a graph comparing the difference in the number of document that may be stored by embedding method according to memory capacity;

FIG. 4 illustrates an example of mapping a token embedding of a target document into a real-valued space of a target dimension and generating a binary hypervector through binarization and bit packing, in a retrieval-augmented generation apparatus according to an example embodiment;

FIG. 5 illustrates an example of clustering hypervectors within hyperdimensional space according to a similarity threshold and generating a target graph in which a cluster centroid is determined as a node, in a retrieval-augmented generation apparatus according to an example embodiment;

FIG. 6 illustrates an example of determining a retrieved document similar to a query hypervector in a retrieval-augmented generation apparatus according to an example embodiment;

FIG. 7 illustrates an example of determining a retrieved document similar to a query hypervector in a retrieval-augmented generation apparatus according to an example embodiment;

FIG. 8 illustrates an example of determining a retrieved document similar to a query hypervector in a retrieval-augmented generation apparatus according to an example embodiment;

FIG. 9 illustrates an example of determining a retrieved document similar to a query hypervector in a retrieval-augmented generation apparatus according to an example embodiment; and

FIG. 10 illustrates an example of determining a retrieved document similar to a query hypervector in a retrieval-augmented generation apparatus according to an example embodiment.

In relation to description of drawings, the same or similar reference numerals may be used for the same or similar components.

### DETAILED DESCRIPTION

The specific structural or functional descriptions of example embodiments according to the concept of the present invention described herein are merely intended for the purpose of describing the example embodiments according to the concept of the present invention and the example embodiments according to the concept of the present invention may be implemented in various forms and are not construed as limited to the example embodiments described herein.

Various modifications may be made to the example embodiments according to the concept of the present invention and thus, the example embodiments are illustrated in the drawings and described in detail through the present specification. However, it should be understood that the example embodiments according to the concept of the present invention are not construed as limited to specific implementations and should be understood to include all changes, equivalents, and replacements within the idea and the technical scope of the present invention.

Although terms of “first,” “second,” and the like are used to explain various components, the components are not limited to such terms. These terms are used only to distinguish one component from another component. For example, a first component may be referred to as a second component, or similarly, the second component may be referred to as the first component without departing from the scope of rights according to the concept of the present invention.

When it is mentioned that one component is “connected” or “accessed” to another component, it may be understood that the one component is directly connected or accessed to another component or that still other component is interposed between the two components. In addition, it should be noted that if it is described in the specification that one component is “directly connected” or “directly accessed” to another component, still other component is absent therebetween. Likewise, expressions, for example, “between” and “immediately between” and “adjacent to” and “immediately adjacent to” may also be construed as described in the foregoing.

The terminology used herein is for the purpose of describing specific example embodiments only and is not to be limiting of the present invention. As used herein, the singular forms “a,” “an,” and “the” are intended to include the plural forms as well, unless the context clearly indicates otherwise. It will be further understood that the terms “comprises/includes” or “has,” when used in this specification, specify the presence of stated features, integers, stages, operations, components, parts, or combinations thereof, but do not preclude the presence or addition of one or more other features, integers, stages, operations, components, parts, or combinations thereof.

Unless otherwise defined, all terms including technical and scientific terms used herein have the same meaning as commonly understood by one of ordinary skill in the art to which the present invention pertains. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

The term “module” used herein may refer to hardware capable of performing functions and operations according to the respective names described in this specification, may also refer to a computer program code that may perform a specific function and operation, or may refer to an electronic recording medium, for example, a processor or a microprocessor, in which the computer program code capable of performing the specific function and operation is loaded.

That is, the module may refer to a functional and/or structural combination of hardware for performing the technical spirit of the present invention and/or software for driving the hardware.

Hereinafter, example embodiments will be described in detail with reference to the accompanying drawings. However, the scope of the claims is not limited to or restricted by the example embodiments. Like reference numerals presented in the respective drawings refer to like components throughout the present specification.

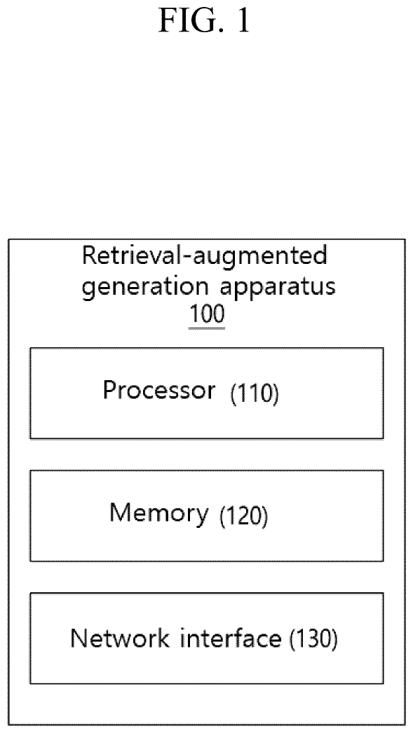

FIG. 1 is a block diagram illustrating a retrieval-augmented generation apparatus according to an example embodiment.

A retrieval-augmented generation apparatus 100 described herein refers to a system that includes hardware and software components for performing operations of hyperdimensional computing, and may include a processor 110, a memory 120, and a network interface 130. The retrieval-augmented generation apparatus 100 may be implemented as a computing device in various forms, for example, a typical graphics processing unit (GPU) or tensor processing unit (TPU)-based learning server, a cloud-based machine learning platform, and an on-device learning environment.

The retrieval-augmented generation apparatus 100 may be implemented as a printed circuit board (PCB) such as a motherboard, an integrated circuit (IC), or a system on chip (SoC). For example, the retrieval-augmented generation apparatus 100 may be implemented as an application processor.

Also, the retrieval-augmented generation apparatus 100 may be implemented within a personal computer (PC), a data server, or a portable device.

The portable device may be implemented as a laptop computer, a mobile telephone, a smart phone, a tablet PC, a mobile Internet device (MID), a personal digital assistant (PDA), an enterprise digital assistant (EDA), a digital still camera, a digital video camera, a portable multimedia player (PMP), a personal navigation device or a portable navigation device (PND), a handheld game console, an e-book, or a smart device. The smart device may be implemented as a smart watch, a smart band, or a smart ring.

The network interface 130 may receive a query hypervector.

The processor 110 may process data stored in the memory 120. The processor 110 may execute a computer-readable code (e.g., software) stored in the memory 120 and instructions caused by the processor 110.

The “processor 110” may be a data processing device implemented as hardware having circuitry with a physical structure to execute desired operations. For example, the desired operations may include instructions or a code included in a program.

For example, the data processing device implemented as hardware may include a microprocessor, a central processing unit, a processor core, a multi-core processor, a multiprocessor, an application-specific integrated circuit (ASIC), and a field programmable gate array (FPGA).

The memory 120 may store instructions (or program) executable by the processor 110. For example, the instructions may include instructions for executing an operation of the processor 110 and/or an operation of each component of the processor 110.

The memory 120 may be implemented as a volatile memory device or a nonvolatile memory device.

The volatile memory device may be included as dynamic random access memory (DRAM), a static random access memory (SRAM), a thyristor RAM (T-RAM), a zero capacitor RAM (Z-RAM), or a twin transistor RAM (TTRAM).

The nonvolatile memory device may be implemented as an electrically erasable programmable read-only memory (EEPROM), a flash memory, a magnetic RAM (MRAM), a spin-transfer torque (STT)-MRAM, a conductive bridging RAM (CBRAM), a ferroelectric RAM (FeRAM), a phase change RAM (PRAM), a resistive memory (resistive RAM (RRAM)), a nanotube RRAM, a polymer RAM (PoRAM), a nano floating gate memory (NFGM), a holographic memory, a molecular electronic memory device, or an insulator resistance change memory.

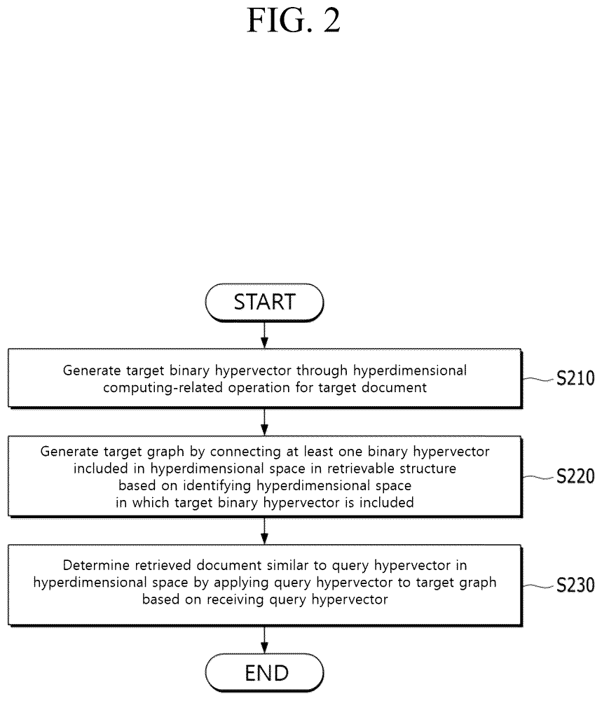

FIG. 2 is a flowchart illustrating a retrieval-augmented generation method according to an example embodiment.

In operation S210, a processor (e.g., processor 110 of FIG. 1) according to an example embodiment may generate a target binary hypervector through hyperdimensional computing (HDC)-related operation for a target document.

For example, the target document may represent text data of a document unit to be retrieved in retrieval-augmented generation (RAG). In detail, the target document may include various natural language-based text that is likely to include information related to a user query. The target document may be tokenized and may be decomposed into a plurality of token units. The token may be converted to a high dimension of an embedding token and may be utilized for postprocessing. The target document may be projected into the hyperdimensional space with preserving a document level of semantic information, and may be represented as a semantic vector that may be usefully utilized for search or generation tasks.

For example, hyperdimensional computing may represent an information processing framework that performs an operation based on a distributed representation in a high dimension by mimicking the computational principle of the biological brain. Hyperdimensional computing represents each object (e.g., token, document, etc.) as a vector in the hyperdimensional space of typically thousands of dimensions or more. The vector includes a binary or bipolar value. The hyperdimensional computing may realize functions, such as similarity comparison, combination, and memory through operations between vectors, and is suitable for large-scale information processing system due to its excellent tolerance and scalability. In particular, each component of information may be encoded in a distributed manner in a high-dimensional space, and they may be combined or reduced to form a larger unit of representation.

For example, the target binary hypervector may represent a high-dimensional binary vector generated through the hyperdimensional computing operation using information extracted from the target document. The target binary hypervector may be in a space of thousands of dimensions with each dimension including 0 or 1. The binary hypervector may include semantic information of the target document and may be effectively utilized for similarity-based search or indexing due to its high memory efficiency and computational efficiency. The target binary hypervector is used as input for operation, such as similarity comparison with other documents, clustering, and graph generation. For example, for clarity of explanation herein, a first document may be represented as a first binary hypervector, a second document may be represented as a second binary hypervector, and a target document may be represented as a target binary hypervector.

For example, retrieval-augmented generation may refer to an operation of retrieving relevant information from a large collection of externally stored documents and generating a new response or content based on retrieved information. Unlike a natural language processing-based generation model that generates a response on its own, retrieval-augmented generation may generate a realistic and precise response by initially retrieving actual documents related to a query and then providing retrieved documents as input to a generative model. Retrieval-augmented generation may increase recency, accuracy, and reliability by allowing the generative model to access external knowledge rather than relying solely on internal parameters for all knowledge.

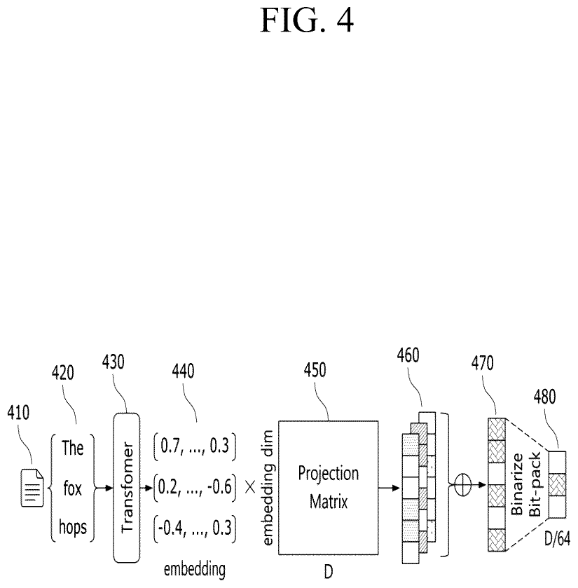

An operation of generating a target binary hypervector is described below with reference to FIG. 4.

In operation S220, the processor may generate a target graph by connecting at least one binary hypervector included in a hyperdimensional space in a retrievable structure based on identifying the hyperdimensional space in which the target binary hypervector is included.

For example, hyperdimension refers to very high dimensions greater than a few thousand dimensions and may typically include 1000 or more dimensions. In hyperdimension, each dimension may represent an individual information unit, and may efficiently verify similarity and distribution between information within the entire dimensional space through metrics, such as a Hamming distance and cosine similarity. Hyperdimensional representation is more robust against noise than conventional low-dimensional or high-dimensional representation, has characteristics of better preserving semantic similarity, and may be utilized as an information representation technique that mimics a biological neural representation method or cognitive mechanism.

For example, the hyperdimensional space is a mathematical space in which a plurality of hyperdimensional vectors (e.g., target binary hypervectors) are distributed, and may refer to a space in which a plurality of information representations expressed as a binary hypervector are arranged based on the specific number of dimensions. The hyperdimensional space may define relationship between neighbor vectors through the Hamming distance between binary hypervectors or other similarity criteria, and may be utilized for indexing, retrieval, and classification by reflecting semantic similarity or distribution characteristics between data. Vectors included in the hyperdimensional space have low sparsity and distribution close to “orthogonal,” which enables a structural and computationally efficient search operation.

For example, the target graph may refer to a graph structure that sets a plurality of binary hypervectors included in the hyperdimensional space as nodes and includes edges connected according to the Hamming distance between nodes or other similarity criteria. The target graph is sparsely structured to maximize the retrieval performance. Each node of the target graph may represent a representative vector (e.g., centroid binary hypervector) of an individual document or cluster. Each edge of the target graph may form a retrieval path between semantically similar vectors. The target graph may be configured in the form of an undirected graph or a small world graph in consideration of the retrieval efficiency, and may be used as an index structure for quickly retrieving a proximity vector (or similar vector) for a query hypervector in a retrieval-augmented generation apparatus (e.g., retrieval-augmented generation apparatus 100 of FIG. 1).

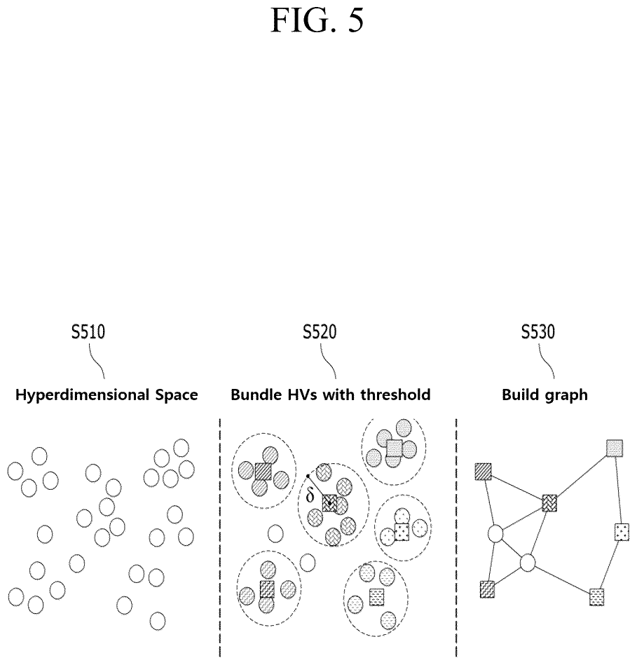

An operation of generating the target graph is further described with reference to FIG. 5.

In operation S230, the processor may determine a retrieved document similar to a query hypervector in the hyperdimensional space by applying the query hypervector to the target graph based on receiving the query hypervector.

For example, the query hypervector refers to a high-dimensional binary hypervector that is generated in response to a user query or an input query and may represent distributed representation that contains semantic information of a query based on hyperdimensional computing. The query hypervector is generated in such a manner that text of the input query is decomposed into token units, embedded through a language model such as a transformer, mapped to the hyperdimensional space through a fixed random projection or operation process, and thereby binarized. The query hypervector may be compared based on criteria such as the Hamming distance with a plurality of nodes (e.g., centroid binary hypervector) within the target graph and may be used to retrieve a semantically most similar document cluster or document.

For example, the input query refers to a request for information in natural language or other formats provided from a user or an external system, and may represent input data that serves as a starting point for retrieving a relevant document or generating text in the retrieval-augmented generation apparatus. The input query may be expressed in the form of a sentence, a phrase, a question, or a keyword, and may be converted into a query hypervector through a tokenization process and an embedding process.

For example, the retrieved document may refer to a document that is retrieved by applying the query hypervector to the target graph and then is determined to be similar to the query hypervector within the hyperdimensional space. The retrieved document is determined through a hyperdimensional computing-based vector similarity computation, for example, Hamming distance or other distance-based search algorithms, and may be determined to be most similar to the query hypervector among actual document vectors adjacent to or connected to the centroid binary hypervector of the target graph.

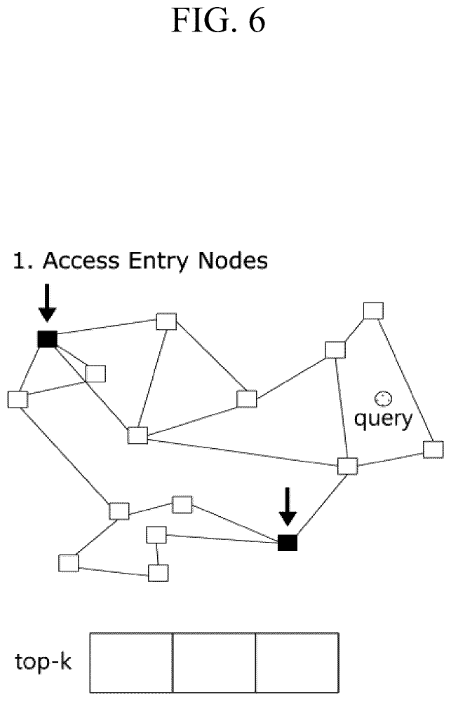

An operation of determining a retrieved document similar to a query hypervector in the hyperdimensional space is described below with reference to FIGS. 6 to 10.

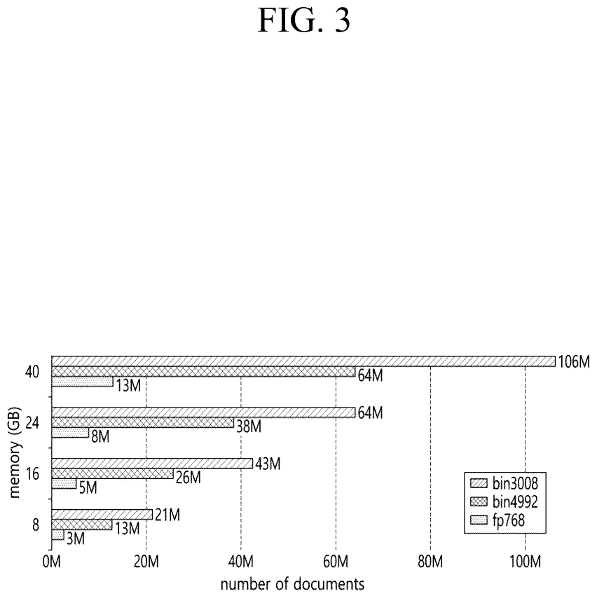

FIG. 3 is an example of a graph comparing the difference in the number of document that may be stored by embedding method according to memory capacity.

Referring to FIG. 3, the horizontal axis of the graph represents the number of storable documents, and the vertical axis of the graph represents memory capacity (in GB) available to the system. The graph shows the number of storable documents according to different embedding methods.

Items shown in the graph may represent cases of real number embedding (fp768), 4,992-dimensional binary hypervector (bin4992), and 3,008-dimensional binary hypervector (bin3008).

Under the same memory capacity, a binary hypervector method (e.g., bin3008 or bin4992) may store much more documents than a real-valued embedding method (i.e., fp768). For example, in the case of using 16 GB of memory, the real-valued embedding method may store about 5M documents. On the other hand, the bin4992 method may store about 26M documents, and the bin3008 method may store about 43M documents. When the memory capacity increases to 40 GB, the bin3008 method may store about 106M documents, showing the highest storage efficiency.

The results of FIG. 3 show that a hyperdimensional computing operation-based retrieval-augmented generation apparatus (e.g., retrieval-augmented generation apparatus 100 of FIG. 1) according to an example embodiment may maximize the utilization of memory resources by utilizing a binary hypervector. In particular, the binary hypervector may maintain the precise semantic structure through high-dimensional binary representation and may enable bit-based compression, making it possible to process a large collection of documents with a much smaller memory space than real-valued embedding. The memory efficiency may directly contribute to improving not only simple storage but also real-time processing performance of retrieval-augmented generation. That is, the retrieval-augmented generation apparatus based on operations of hyperdimensional computing may perform indexing of more documents and perform fast retrieval under the same hardware resources.

FIG. 4 illustrates an example of mapping a token embedding of a target document into a real-valued space of a target dimension and generating a binary hypervector through binarization and bit packing, in a retrieval-augmented generation apparatus according to an example embodiment.

A processor (e.g., processor 110 of FIG. 1) according to an example embodiment may generate a target binary hypervector 480 through a hyperdimensional computing-related operation for a target document 410.

For example, the processor may acquire embedding tokens (vectors) 440 by applying, to a pretrained transformer encoder 430, each of a plurality of tokens (vectors) 420 that constitute the target document 410.

For example, a token is a smallest semantic unit that constitutes the target document 410, and refers to a string unit that may include a word, a sub-word, or a punctuation mark. The target document 410 is segmented into sentences through a tokenizer, and each token is used as a processing unit for generating an embedding or a hypervector. Herein, an operation of extracting semantic information from each token unit by segmenting the content of the target document 410 into a plurality of tokens (vectors) is described.

For example, the transformer encoder 430 may represent an artificial neural network model that performs a self-attention-based processing operation on each of the plurality of input tokens (vectors) 420 and produces a vector representation reflecting semantic information of each token within the context. The transformer encoder 430 typically includes a plurality of encoder blocks, and each block includes an attention layer and a feedforward layer. The processor may convert the tokens (vectors) 420 of the target document 410 to an embedding token using the pretrained transformer encoder 430.

For example, the embedding token refers to a representation that each token is converted to a vector in a fixed-dimensional, continuous real-valued space. The embedding token may be determined to numerically encode a semantic characteristic of a token within context and to be operable within a real-valued space. The processor may use the embedding token as an initial value to project the embedding token into a high-dimensional space and convert the same to a binary hypervector.

For example, the processor may acquire a token hypervector 460 in which the embedding tokens (vectors) 440 are mapped to the real-valued space of a target dimension for hyperdimensional computing, based on a fixed random projection matrix 450.

For example, the fixed random projection matrix 450 refers to a linear transformation matrix for mapping an embedding token in the real-valued space to a vector in the hyperdimensional space, and may have the characteristic that each element is randomly initialized according to the fixed probability distribution (e.g., uniform distribution of +1 or −1) and fixed without a learning process. The fixed random projection matrix 450 may be used to expand or change a dimension of the embedding token to the target dimension, and may provide vector generation converted to a form suitable for hyperdimensional computing.

For example, the target dimension refers to a dimension of a high-dimensional real-valued or binary vector space used for information representation in hyperdimensional computing, and may be set to the high-dimensional space with several thousand or more dimensions. The target dimension is set to a dimension much larger than the embedding dimension.

For example, the token hypervector 460 refers to a vector that is generated by applying the embedding token acquired from the transformer encoder 430 to the fixed random projection matrix 450 for a single token, and may represent a high-dimensional vector that distributedly represents semantic information of the token within the hyperdimensional space. The token hypervector 460 is subject to an operation of hyperdimensional computing, and may be used for generation of a target graph, clustering, document representation, and retrieval.

For example, the processor, based on operations of hyperdimensional computing, may generate a binary hypervector in which information is evenly distributed across all dimensions, each component equally contributes to the overall representation, and individual bits have no inherent meaning. The distributed structure is robust against noise and allows for graceful degradation although some corruption occurs. The embedding token may encode not only individual meaning of a token but also contextual relationship within the sequence, and may include representation suitable for transformation to the hyperdimensional space.

The token hypervector 460 may be expressed as Equation 1 below:

$${y}_{i} = {Px}_{i} \qquad [ Equation 1 ]$$

Here, yᵢ denotes the token hypervector 460, P denotes the fixed random projection matrix 450, and xᵢ denotes the embedding token.

The processor may identify an attention mask for the transformer encoder 430, and may perform update to exclude, from the token hypervector 460, a token that is meaningless for the hyperdimensional computing-related operation based on the attention mask.

For example, the attention mask is masking information based on a binary value to control whether a specific token participates in an attention operation in input sequence of the transformer encoder 430. The attention mask may be designed to exclude a padding token, a meaningless symbol, or a token with no semantic connection at a specific location within the input sequence from the influence scope of the attention operation.

An updated token hypervector 470 may be expressed as Equation 2 below:

$${y}_{doc} = {\sum }_{i = 1}^{n} {m}_{i} \cdot {y}_{i} \qquad [ Equation 2 ]$$

Here, y_{doc} denotes a token hypervector for which update is performed, mᵢ denotes the attention mask, and yᵢ denotes the token hypervector 460 of Equation 1.

For example, the processor may project tokens (vectors) of each document into the high-dimensional space and then aggregate token-level hypervectors into a single vector that represents the entire document. The processor may preserve distributed semantic information of each component by combining a plurality of token hypervectors into a single composite vector based on bundling among operations of hyperdimensional computing.

For example, the processor may perform binarization of the token hypervector by applying a sign function to each target dimension of the token hypervector. The processor may generate a target binary hypervector 480 as a result of performing binarization of the token hypervector.

For example, the sign function refers to a function that receives a real number value and outputs the same as a binary value of 0 or 1 based on sign information. The sign function is used as a core component of binarization operation to convert a real number vector to a binary hypervector in a hyperdimensional computing operation process. For example, through the sign function, the processor outputs 1 if each real-valued dimension value that constitutes the token hypervector is greater than or equal to 0, and outputs 0 if it is less than 0. The processor may increase memory efficiency and computational simplicity by converting a real-valued high-dimensional representation to a binary representation through the sign function and by preserving relative information in each dimension.

The target binary hypervector 480 may be expressed as Equation 3 below:

$${h}_{doc} [ d ] = \{ \begin{matrix}1 , if {y}_{doc} [ d ] \geq 0 \\ 0 , if {y}_{doc} [ d ] < 0\end{matrix} for d = 1 , … , D \qquad [ Equation 3 ]$$

Here, h_{doc} denotes the target binary hypervector 480, y_{doc} denotes the updated token hypervector 470 on which update of Equation 2 is performed, and D denotes the target dimension.

For example, the processor may store the target binary hypervector 480 in at least one memory (e.g., memory 120 of FIG. 1) in a compressed format by performing bit-packing that divides the target binary hypervector 480 into predetermined unit sizes based on the number of bits of the target binary hypervector 480. For example, to reduce memory usage, the target binary hypervector 480 is bit-packed in 64-bit integer units and thereby stored. The processor may perform compact storage and efficient computation based on bit-operation. For example, a 3008-bit binary hypervector may be stored only as 47 int64 values, which may achieve memory saving of 8 times or more compared to a 768-dimensional floating-point embedding (3072 bytes). The processor may select the target dimension D such that the binary hypervector may be divided into 64-bit integer units. The processor may use the bit operation that is suitable for a parallel operation, such as XOR and population count when calculating the Hamming distance. Through this, in CUDA architecture, each thread of warp may independently process a 64-bit word through an intrinsic function, such as popcll, which makes warp-level level parallel processing efficient. 64-bit layout also works well with CPU vectorization, so may support an efficient bit-parallel operation that utilizes AVX2 and AVX-512 instruction sets.

FIG. 5 illustrates an example of clustering hypervectors within hyperdimensional space according to a similarity threshold and generating a target graph in which cluster centroid is determined as a node, in a retrieval-augmented generation apparatus according to an example embodiment.

A processor (e.g., processor 110 of FIG. 1) according to an example embodiment may generate a target graph by connecting at least one binary hypervector included in a hyperdimensional space in a retrievable structure based on identifying the hyperdimensional space in which the target binary hypervector is included.

In operation S510, the processor may identify the hyperdimensional space in which at least one binary hypervector is included.

For example, the processor may determine each of the at least one binary hypervector to be unassigned, and may determine the unassigned binary hypervector as a temporary vector based on a similarity threshold based on a Hamming distance between the at least one binary hypervector.

In operation S520, the processor may generate a target cluster.

For example, the unassigned state refers to an initial state in which the binary hypervector does not belong to any cluster. Before clustering a plurality of binary hypervectors in the hyperdimensional space, each binary hypervector is maintained in the unassigned state without any affiliation information, and whether to assign this is determined by determining a similarity with a temporary vector or a centroid vector in a clustering processing process. The unassigned state is utilized for an initial processing stage for selecting a search order or a reference vector.

For example, the Hamming distance refers to the different number of bits between two binary hypervectors with the same length, and may represent a criterion that quantitatively measures similarity or difference between two vectors. Since each dimension is configured with 0 or 1 in the hyperdimensional space, the Hamming distance may be used as a representative distance measurement method that may efficiently calculate similarity between vectors. For example, the smaller the Hamming distance, the more likely the two binary hypervectors may be determined to be semantically similar.

For example, the similarity threshold may represent a threshold that is used as a criterion for determining the similarity between Hamming distance-based vectors. If the Hamming distance between the two binary hypervectors is less than or equal to the similarity threshold, the two vectors may be determined to be similar and may be assigned to the same cluster. The similarity threshold is a parameter that adjusts the cluster density or search range, and may directly affect precision and comprehensiveness of clustering results.

Here, the similarity threshold may be expressed as Equation 4 below:

$$τ = ⌈ \frac{D}{4} ⌉ \qquad [ Equation 4 ]$$

Here, τ denotes the similarity threshold, and D denotes the target dimension.

For example, the processor may generate a target cluster by clustering similar binary hypervectors among at least one binary hypervector based on a greedy single-pass algorithm that includes binary hypervectors each of which the Hamming distance is less than the similarity threshold.

For example, the greedy single-pass algorithm may represent a search method that starts with a single binary hypervector as an initial reference and sequentially selects adjacent binary hypervectors of which similarity criterion (e.g., Hamming distance) is less than the similarity threshold, thereby expanding the cluster. The greedy algorithm may correspond to a greedy strategy in that the greedy algorithm selects the most similar (i.e., shortest Hamming distance) binary hypervector at each stage, completes the cluster in a single pass, and does not look back at the selection results from a previous stage. Since the search is performed in a single pass, it is computationally efficient and may be suitable for quickly clustering a large-scale binary hypervector set.

For example, the target cluster may represent a single semantic unit set formed by clustering a plurality of binary hypervectors having similarity within the hyperdimensional space. In detail, the target cluster may be determined to be similar based on the Hamming distance between binary hypervectors, and may include vectors to be included in the same cluster through the greedy single-pass algorithm. In the hyperdimensional space, each cluster has internally high cohesion and may maintain separation distinct from an external cluster.

The target cluster may be expressed as Equation 5 below:

$${C}_{k} = \{ {h}^{( j )} ∈ H \vert Hamming ( {h}^{( j )} , {h}^{( i )} ) < τ and {h}^{( j )} unassigned \} \qquad [ Equation 5 ]$$

Here, Cₖ denotes the target cluster, h⁽ⁱ⁾ denotes a center point of the target cluster, h^{(j)} denotes an unassigned binary hypervector that may be included in the target cluster in the hyperdimensional space, and t denotes the similarity threshold of Equation 4.

For example, the processor may indicate all binary hypervectors as unassigned. When the processor encounters an unassigned binary hypervector (e.g., h⁽ⁱ⁾ of Equation 5) while sequentially traversing binary hypervectors in the hyperdimensional space, the processor may specify it as a center point of a cluster. Then, the processor may calculate the Hamming distance between the unassigned binary hypervector (e.g., h^{(j)} of Equation 5) and the center point of the cluster. If the Hamming distance is less than a predefined threshold (e.g., τ of Equations 4 and 5), the processor may include the unassigned binary hypervector in the cluster and perform assignment processing.

In operation S530, the processor may generate the target graph.

For example, the processor may determine a centroid binary hypervector that represents the target cluster by determining a plurality of binary hypervectors included in the target cluster as a bit having a majority value for each target dimension, and may determine the centroid binary hypervector as a node of the target graph.

For example, the centroid binary hypervector may represent a binary hypervector that represents the entire cluster, determined based on a bit value (0 or 1) that occupies more than a half of bit values appearing in the same target dimension of each of the plurality of binary hypervectors included in the target cluster.

The centroid binary hypervector may be expressed as Equation 6 below:

$${C}_{d}^{( k )} = \{ \begin{matrix}1 , if {\sum }_{i = 1}^{n} {h}_{d}^{( i )} > \frac{n}{2} for d = 1 , … , D \\ 0 , otherwise\end{matrix} \qquad [ Equation 6 ]$$

Here,

$${C}_{d}^{( k )}$$

denotes the centroid binary hypervector of a k^{th} target cluster, and

$${h}_{d}^{( i )}$$

denotes an i^{th} binary hypervector included in the target cluster.

For example, in the hyperdimensional space, each cluster is compressed to a centroid vector that represents the corresponding cluster. A binary hypervector that has no close neighbor within a clustering threshold may be regarded as a singleton cluster and may be included in a graph as a separate centroid node. The centroid binary hypervectors represent semantic information of the cluster and used as nodes in the target graph. A majority vote method reflects the core principle of operations of hyperdimensional computing. In detail, information is evenly distributed across all dimensions and semantic similarity is revealed through a repeatedly appearing pattern rather than an individual characteristic. Calculation of the centroid binary hypervector emphasizes a common component within the cluster and reduces the influence of noise or outlier value. Since each bit is independently processed, the operation is very suitable for parallelization and may be efficiently performed in modern hardware.

For example, the processor may determine the Hamming distance between the centroid binary hypervector of a cluster adjacent to the target cluster and the centroid binary hypervector of the target cluster as an edge of the target graph. The processor may generate the target graph for an undirected graph by symmetrically determining the edge.

The structure of the target graph may be expressed by Equation 7 below:

$$N ( {C}^{( k )} ) = TopM ( \{ Hamming ( {C}^{( k )} , {C}^{( i )} ) \vert i < k \} ) \qquad [ Equation 7 ]$$

Here, N(C^{(k)}) denotes a set of neighbor nodes connected to a C^{(k)}.

In detail, the processor may determine a neighbor node connected to C^{(k)} by calculating the Hamming distance between each newly inserted C^{(k)} and a previously inserted node and by selecting closest M nodes.

FIGS. 6 to 10 illustrate examples of determining a retrieved document similar to a query hypervector in a retrieval-augmented generation apparatus according to an example embodiment.

A processor (e.g., processor 110 of FIG. 1) according to an example embodiment may determine a retrieved document similar to a query hypervector in hyperdimensional space by applying the query hypervector to the target graph based on receiving the query hypervector.

Referring to FIG. 6, the processor may randomly determine an entry node among at least one node included in the target graph and then determine an additional entry node based on a predetermined beam size and a Hamming distance.

For example, the processor may randomly determine the entry node among at least one node included in the target graph. The entry node may be selected to be semantically distributed across the hyperdimensional space of the target graph.

For example, the processor may determine some of nodes that may cover the wide semantic distribution from the entry node as additional entry nodes based on the preset beam size and Hamming distance. The additional entry nodes serve to expand the initial search range and are used as a preprocessing operation to improve the search efficiency.

For example, FIG. 6 represents an example that visually shows an entry node initialization operation, and illustrates that some nodes (indicated with arrows) are selected from among a plurality of nodes on the target graph and search starts based on the selected nodes.

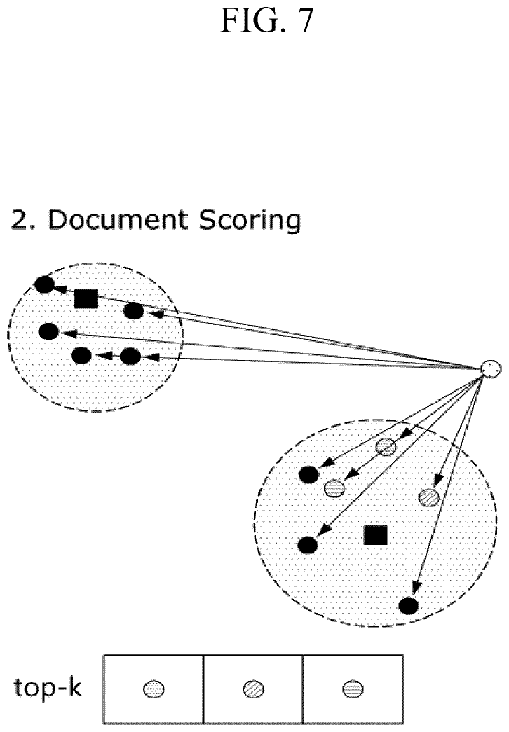

Referring to FIG. 7, the processor may determine a candidate document based on comparison between a plurality of binary hypervectors included in a cluster of each of the entry node and the additional entry node and the query hypervector.

For example, the centroid of a beam is connected to a document binary hypervector set within the cluster. The processor retrieves documents from all clusters included in the beam and calculates the Hamming distance from the query hypervector. Then, the processor may update a top-k heap that maintains k most similar documents and may store ID and distance information of each document.

For example, the beam may represent a set of centroid nodes that represent the current search range during a target graph search process. Each centroid node represents a cluster and is connected to binary hypervectors of documents that belong to the corresponding cluster.

For example, the top-k heap may represent a data structure for maintaining k most similar documents to the query hypervector. The processor may calculate the Hamming distance between each document and the query hypervector during the search process and then may maintain the k most similar documents among documents found so far based on the Hamming distance. A condition that a new document is to insert into the top-k heap may represent a condition that the new document is closer than the farthest document among the existing k documents. The processor may store ID and Hamming distance information of each document together in the top-k heap.

For example, the candidate document may refer to a document that is predicted to be similar to the query hypervector. In detail, the candidate documents may include documents that are evaluated for similarity through calculation of the Hamming distance between a plurality of binary hypervectors included in clusters, respectively, represented by the entry node and the additional entry node selected from the target graph and the input query hypervector, and that are preferentially selected based on a predetermined criterion (e.g., top-k). Then, by repeating a scoring and comparison process, a final retrieved document is determined, and the candidate document may represent a promising search target in a stage before being selected as the final search result.

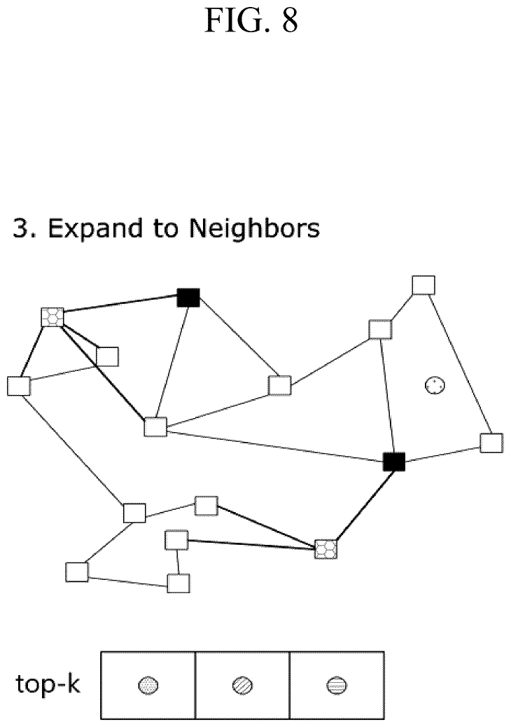

Referring to FIG. 8, the processor may identify a neighbor node that is an adjacent node connected to the entry node by edge.

For example, to expand the search range in the target graph, the processor may explore adjacent nodes of center points included in a current beam. Adjacent nodes (i.e., neighbor nodes) represent a semantically adjacent document cluster, and relevance may be determined by calculating the Hamming distance from the query hypervector for nodes that have not yet been visited.

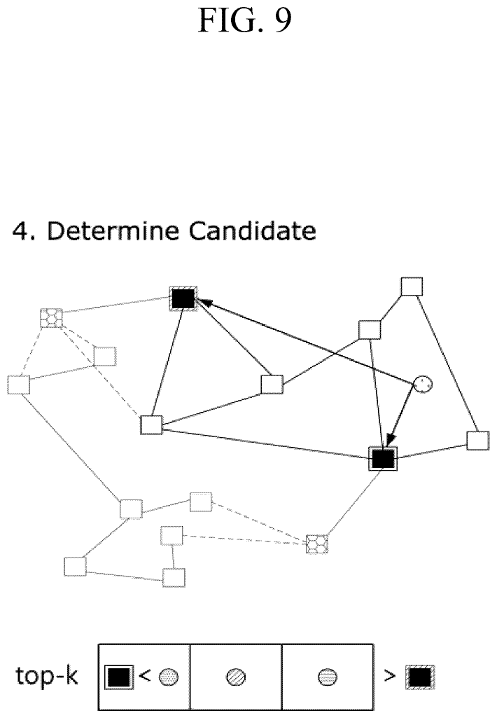

Referring to FIG. 9, the processor may determine a comparative candidate document based on comparison between a plurality of binary hypervectors included in a cluster of a neighbor node and the query hypervector.

For example, the processor may select the closest unvisited maximum B centroid nodes based on the Hamming distance and then set the same as a subsequent beam (i.e., including neighbor node). The center point is considered as a representative vector of the corresponding cluster and approximates document similarity and the overall computational amount is reduced and search efficiency is improved by excluding an insignificant cluster from search.

For example, the comparative candidate document may represent an alternative document of which similarity is to be evaluated with a candidate document, derived through comparison between binary hypervectors included in a cluster of the currently selected neighbor node and the query hypervector.

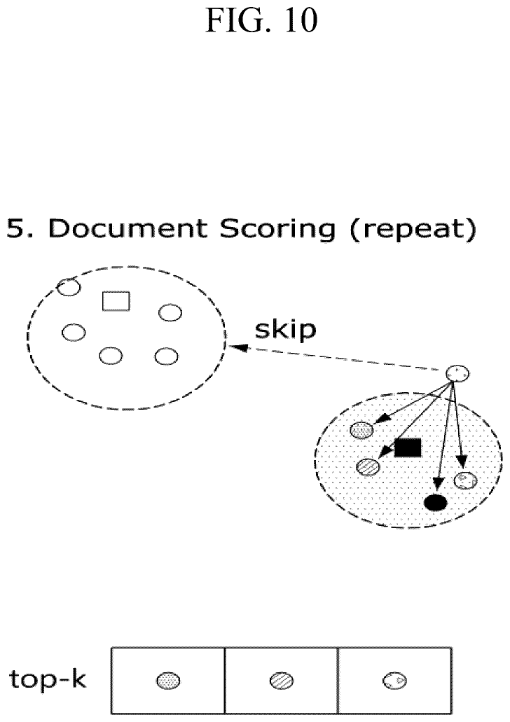

Referring to FIG. 10, the processor may determine a retrieved document by performing update of the candidate document based on comparison between a first score between the candidate document and the query hypervector and a second score between the comparative candidate document and the query hypervector.

For example, the processor may re-evaluate documents connected to the corresponding center points based on the updated beam (i.e., neighbor node). If a new document is more similar to the worst document within the current top-k heap, the processor updates the heap. The processor may repeatedly perform the aforementioned operation until there are no unvisited center points or until the top-k results no longer improve.

For example, the processor may repeatedly update the candidate document set by comparing the first score between the candidate document and the query hypervector and the second score between the comparative candidate document and the query hypervector. The first score or the second score may be calculated based on the Hamming distance or another similarity measure. The processor may update the heap by removing a lowest scored (i.e., least similar) document within the top-k heap based on the comparison result and by inserting a more similar document.

For example, an iterative candidate set update process may efficiently reduce the search space and, at the same time, gradually improve the quality of a retrieved document and may determine a retrieved document set that includes only documents most similar to the query hypervector.

For example, when there are no more unvisited center points or when documents within the top-k heap no longer change through iterative search, that is, when additional performance improvement is not expected, the processor may terminate the search. Through this iterative search and update process, search efficiency and accuracy may be achieved within the hyperdimensional space of high dimensions.

The apparatuses described herein may be implemented using hardware components, software components, and/or combination of the hardware components and the software components. For example, the apparatuses and the components described herein may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. A processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied in any type of machine, component, physical equipment, virtual equipment, computer storage medium or device, or in a propagated signal wave to be interpreted by the processing device or to provide instructions or data to the processing device. The software also may be distributed over network coupled computer systems so that the software is stored and executed in a distributed fashion. The software and data may be stored by one or more computer readable storage mediums.

The methods according to the example embodiments may be implemented in the form of program instructions executable through various computer methods and recorded in computer-readable media. Also, the media may include, alone or in combination with the program instructions, data files, data structures, and the like. Program instructions stored in the media may be those specially designed and constructed for the example embodiments, or they may be well-known and available to those having skill in the computer software arts. Examples of the media include magnetic media such as hard disks, floppy disks, and magnetic tapes; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The hardware device may be configured to act as at least one software module for performing operations of example embodiments, or vice versa.

Although the example embodiments are described with reference to some specific example embodiments and accompanying drawings, it will be apparent to one of ordinary skill in the art that various alterations and modifications in form and details may be made in these example embodiments without departing from the description. For example, suitable results may be achieved if the described techniques are performed in different order, and/or if components in a described system, architecture, device, or circuit are combined in a different manner, and/or replaced or supplemented by other components or their equivalents.

Therefore, other implementations, other example embodiments, and equivalents of the claims are to be construed as being included in the claims.

What is claimed is:

1. A hyperdimensional computing-based retrieval-augmented generation apparatus comprising:
a network interface;
at least one processor operatively connected to the network interface; and
at least one memory operatively connected to the at least one processor,
wherein the at least one memory stores instructions that, when executed, cause the at least one processor to:
generate a target hypervector through hyperdimensional computing (HDC)-related operation for a target document;
generate a target graph by connecting at least one hypervector included in a hyperdimensional space in a retrievable structure based on identifying the hyperdimensional space in which a target binary hypervector is included; and
determine a retrieved document similar to a query hypervector in the hyperdimensional space by applying the query hypervector to the target graph based on receiving the query hypervector.

2. The retrieval-augmented generation apparatus of claim 1, wherein the at least one memory stores instructions that, when executed, cause the at least one processor to:
acquire embedding tokens (vectors) by applying, to a pretrained transformer encoder, each of a plurality of tokens (vectors) that constitute the target document; and
acquire a token hypervector in which the embedding tokens (vectors) are mapped to a real-valued space of a target dimension related to the hyperdimensional computing, based on a fixed random projection matrix.

3. The retrieval-augmented generation apparatus of claim 2, wherein the at least one memory stores instructions that, when executed, cause the at least one processor to,
identify an attention mask for the transformer encoder, and
perform update to exclude, from the token hypervector, a token that is meaningless for the hyperdimensional computing-related operation based on the attention mask.

4. The retrieval-augmented generation apparatus of claim 3, wherein the at least one memory stores instructions that, when executed, cause the at least one processor to,
perform binarization of the token hypervector by applying a sign function to each target dimension of the token hypervector, and
generate the target hypervector as a result of performing binarization of the token hypervector.

5. The retrieval-augmented generation apparatus of claim 4, wherein the at least one memory stores instructions that, when executed, cause the at least one processor to store the target hypervector in the at least one memory in a compressed format by performing bit-packing that divides the target hypervector into predetermined unit sizes based on the number of bits of the target hypervector.

6. The retrieval-augmented generation apparatus of claim 2, wherein the at least one memory stores instructions that, when executed, cause the at least one processor to,
determine each of the at least one hypervector to be unassigned,
determine the unassigned hypervector as a temporary vector based on a similarity threshold based on a Hamming distance between the at least one hypervector, and
generate a target cluster by clustering similar hypervectors among the at least one hypervector based on a greedy single-pass algorithm that includes target hypervectors each of which the Hamming distance is less than the similarity threshold.

7. The retrieval-augmented generation apparatus of claim 6, wherein the at least one memory stores instructions that, when executed, cause the at least one processor to,
determine a centroid hypervector that represents the target cluster by determining a plurality of binary hypervectors included in the target cluster as a bit having a majority value for each target dimension, and
determine the centroid hypervector as a node of the target graph.

8. The retrieval-augmented generation apparatus of claim 7, wherein the at least one memory stores instructions that, when executed, cause the at least one processor to,
determine the Hamming distance between the centroid hypervector of a cluster adjacent to the target cluster and the centroid hypervector of the target cluster as an edge of the target graph, and
generate the target graph for an undirected graph by symmetrically determining the edge.

9. The retrieval-augmented generation apparatus of claim 1, wherein the at least one memory stores instructions that, when executed, cause the at least one processor to,
randomly determine an entry node among at least one node included in the target graph and then determine an additional entry node based on a predetermined beam size and a Hamming distance,
determine a candidate document based on comparison between a plurality of hypervectors included in a cluster of each of the entry node and the additional entry node and the query hypervector, and
determine the retrieved document based on the candidate document.

10. The retrieval-augmented generation apparatus of claim 9, wherein the at least one memory stores instructions that, when executed, cause the at least one processor to,
identify a neighbor node that is an adjacent node connected to the entry node using an edge,
determine a comparative candidate document based on comparison between a plurality of hypervectors included in a cluster of the neighbor node and the query hypervector, and
determine the retrieved document by performing update of the candidate document based on comparison between a first score between the candidate document and the query hypervector and a second score between the comparative candidate document and the query hypervector.

11. A hyperdimensional computing-based retrieval-augmented generation method comprising:
generating a target hypervector through hyperdimensional computing (HDC)-related operation for a target document;
generating a target graph by connecting at least one hypervector included in a hyperdimensional space in a retrievable structure based on identifying the hyperdimensional space in which the target hypervector is included; and
determining a retrieved document similar to a query hypervector in the hyperdimensional space by applying the query hypervector to the target graph based on receiving the query hypervector.

12. The retrieval-augmented generation method of claim 11, wherein the generating of the target hypervector comprises:
acquiring embedding tokens (vectors) by applying, to a pretrained transformer encoder, each of a plurality of tokens (vectors) that constitute the target document; and
acquiring a token hypervector in which the embedding tokens (vectors) are mapped to a real-valued space of a target dimension related to the hyperdimensional computing, based on a fixed random projection matrix.

13. The retrieval-augmented generation method of claim 12, wherein the generating of the target hypervector comprises:
identifying an attention mask for the transformer encoder; and
performing update to exclude, from the token hypervector, a token that is meaningless for the hyperdimensional computing-related operation based on the attention mask.

14. The retrieval-augmented generation method of claim 13, wherein the generating of the target hypervector comprises:
performing binarization of the token hypervector by applying a sign function to each target dimension of the token hypervector; and
generating the target hypervector as a result of performing binarization of the token hypervector.

15. The retrieval-augmented generation method of claim 14, wherein the generating of the target hypervector comprises storing the target hypervector in at least one memory in a compressed format by performing bit-packing that divides the target hypervector into predetermined unit sizes based on the number of bits of the target hypervector.

16. The retrieval-augmented generation method of claim 12, wherein the generating of the target graph comprises:
determining each of the at least one hypervector to be unassigned;
determining the unassigned hypervector as a temporary vector based on a similarity threshold based on a Hamming distance between the at least one hypervector; and
generating a target cluster by clustering similar hypervectors among the at least one hypervector based on a greedy single-pass algorithm that includes target hypervectors each of which the Hamming distance is less than the similarity threshold.

17. The retrieval-augmented generation method of claim 16, wherein the generating of the target graph comprises:
determining a centroid hypervector that represents the target cluster by determining a plurality of hypervectors included in the target cluster as a bit having a majority value for each target dimension; and
determining the centroid hypervector as a node of the target graph.

18. The retrieval-augmented generation method of claim 17, wherein the generating of the target graph comprises:
determining the Hamming distance between the centroid hypervector of a cluster adjacent to the target cluster and the centroid hypervector of the target cluster as an edge of the target graph; and
generating the target graph for an undirected graph by symmetrically determining the edge.

19. The retrieval-augmented generation method of claim 11, wherein the determining of the retrieved document similar to the query hypervector comprises:
randomly determining an entry node among at least one node included in the target graph and then determining an additional entry node based on a predetermined beam size and a Hamming distance;
determining a candidate document based on comparison between a plurality of hypervectors included in a cluster of each of the entry node and the additional entry node and the query hypervector; and
determining the retrieved document based on the candidate document.

20. The retrieval-augmented generation method of claim 19, wherein the determining of the retrieved document similar to the query hypervector comprises:
identifying a neighbor node that is an adjacent node connected to the entry node using an edge;
determining a comparative candidate document based on comparison between a plurality of hypervectors included in a cluster of the neighbor node and the query hypervector; and
determining the retrieved document by performing update of the candidate document based on comparison between a first score between the candidate document and the query hypervector and a second score between the comparative candidate document and the query hypervector.
